(19) United States
(12) Patent Application Publication
(10) Pub. No.: US 2009/0070854 A1
(43) Pub. Date: Mar. 12, 2009

(54) METHOD, APPARATUS AND NETWORK FOR NEGOTIATING MIP CAPABILITY

(75) Inventors: Liang GU, Shenzhen (CN); Jianjun WU, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: Huawei Technologies Co., Ltd., Shenzhen (CN)

(21) Appl. No.: 12/269,468

(22) Filed: Nov. 12, 2008

Related U.S. Application Data
(63) Continuation of application No. PCT/CN2007/070017, filed on May 14, 2007.

(30) Foreign Application Priority Data
May 13, 2006 (CN) 200610082217.7
Aug. 25, 2006 (CN) 200610115151.7

(51) Int. Cl. G06F 21/20

(52) U.S. Cl. 726/1; 726/3

(57) ABSTRACT

The invention provides a method, an apparatus and a network for negotiating MIP capability in a network, including: negotiating the MIP capability through an Authentication and Authorization process and/or an above-physical layer capability negotiation process, to obtain service information that can be provided by the network. With the invention, the network is allowed to choose whether to provide MIP service and relevant service.

### CROSS-REFERENCE TO RELATED APPLICATIONS

This application is a continuation of International Patent Application No. PCT/CN2007/070017, filed May 14, 2007, which claims priority to Chinese Patent Application No. 200610082217.7, filed May 13, 2006 and Chinese Patent Application No. 200610115151.7, filed Aug. 25, 2006, all of which are hereby incorporated by reference in their entirety.

### FIELD OF THE INVENTION

The present invention relates to the field of communication technologies, and more particularly, to a method and an apparatus for negotiating Mobile Internet Protocol (MIP) capability in a network.

### BACKGROUND

A Worldwide Interoperability for Microwave Access (WiMAX) network is illustrated as an example.

The WiMAX network is a Wireless Metropolitan Area Network (WMAN) technology based on IEEE 802.16 standard, and is mainly composed of the following three parts:

Clients, which specifically may be Subscriber Stations (SSs) or Mobile Stations (MSs);

An Access Service Network (ASN), including a Base Station (BS) and an Access Service Network Gateway (ASN-GW);

A Connectivity Service Network (CSN), including logical entities such as a Policy Function (PF) entity, an Authentication Authorization and Accounting (AAA) Server, an Application Function (AF) entity, and so on.

FIG. 1 is a schematic diagram illustrating the logical structure of a WiMAX network. In FIG. 1, an SS/MS denotes a WiMAX terminal, which wirelessly connects to an ASN. Currently, the WMAN access technologies based on IEEE 802.16d/e standards are mainly employed for the wireless side of the WiMAX network.

The ASN mainly includes the following functions: ensuring the establishment of a layer 2 connection between a WiMAX terminal and a WiMAX BS; radio resources management; network discovery; selecting optimum Network Service Provider (NSP) for a WiMAX subscriber; acting as an proxy server to control the Authentication Authorization and Accounting of a WiMAX subscriber in an Proxy MIP; and providing relay for establishing layer 3 application connection on a WiMAX terminal.

The CSN mainly includes the following functions: allocating an Internet Protocol (IP) address for a session of a WiMAX subscriber; providing access to Internet; acting as an AAA proxy or AAA server; performing policy and access control based on subscription data of subscribers; supporting the establishment of a tunnel between an ASN and a CSN; supporting the generation of bills for WiMAX subscribers and the settlement of WiMAX services across operators; supporting the establishment of a roaming tunnel between CSNs; supporting mobility between ASNs; supporting various WiMAX services such as location based service, end-to-end service, multimedia broadcast/multicast service (MBMS), and so on.

It has achieved the consensus in the industry on the applications of IP technology in the WiMAX field, along with the rapid development of Internet technology.

In traditional IP technology, when a host moves into another network segment or sub-network, since different network segments correspond to different IP addresses, the subscriber with the host cannot perform communication by using the original IP address, and the IP address of the host needs to be modified into an IP address of the new sub-network. Moreover, due to various network configurations, the subscriber generally cannot continue to access resources of the original network, and other subscribers cannot reach the subscriber via the original IP address of the subscriber either.

MIP technology resolves the problem of mobility in network layer. With the so called MIP technology, when TCP (Transmission Control Protocol)/IP based networks are used in the case that a moving subscriber is arbitrarily moving and roaming across networks, the subscriber needs not modify the original IP address of the computer and continues to have all rights of the original network. In short, the MIP technology enables universal moving or roaming across networks.

In consideration of the fact that the MIP service is a kind of service provided by the NSP, whether the service is provided depends on the subscription information between a subscriber and the NSP as well as the service policy of the NSP. Therefore, before providing service for the subscriber, a Home-NSP (H-NSP) needs to send relevant service information to an ASN of a Network Access Provider (NAP), and then the ASN determines to finally provide services based on the relevant service information, the actual capability of the subscriber equipment, the actual capability of the ASN, and the service policy of the NAP.

However, since there is no relevant service information for MIP in the prior art, the network is unable to choose whether to provide MIP and relevant services.

### SUMMARY

Accordingly, embodiments of the present invention provide a method, an apparatus and a network for negotiating MIP capability in a network, so as to enable a service provider to choose whether to provide a subscriber with MIP and relevant services.

An embodiment of the present invention provides a method for negotiating MIP capability in a network, wherein the negotiation of the MIP capability is performed through an Authentication and Authorization (AA) process and/or an above-physical layer capability negotiation process, so as to obtain service information that can be provided by the network.

An embodiment of the present invention provides an apparatus for negotiating MIP capability in a network, wherein the apparatus is adapted to negotiate the MIP capability through an AA process and/or an above-physical layer capability negotiation process, so as to obtain service information that can be provided by the network.

An embodiment of the present invention provides a network comprising an ASN and a CSN, wherein the ASN is adapted to obtain service information that can be supported by the network through an AA process.

Embodiments of the present invention makes the network able to choose whether to provide MIP and relevant services, so as to make up the shortage in the prior art.

### BRIEF DESCRIPTION OF THE DRAWINGS

FIG. 1 is a schematic diagram illustrating the logical structure of a WiMAX network;

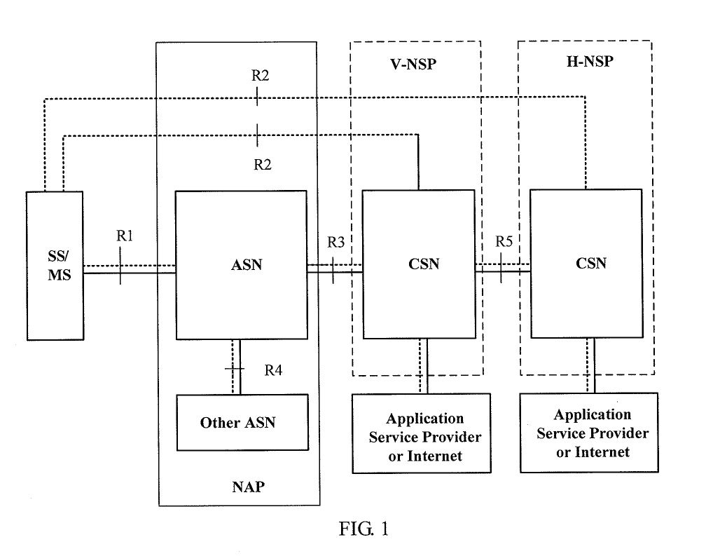

FIG. 2 is a flowchart illustrating a method for negotiating MIP capability in a network according to a first embodiment of the present invention;

FIG. 3 is a flowchart illustrating a method for negotiating MIP capability in a network according to a second embodiment of the present invention; and

FIG. 4 is a flowchart illustrating a method for negotiating MIP capability in a network according to a third embodiment of the present invention.

### DETAILED DESCRIPTION

An embodiment of the present invention provides a method for negotiating MIP capability in a network, wherein the network includes an ASN and at least one CSN. When a subscriber terminal such as an MS enters the network, the negotiation of MIP capability is performed through an Authentication and Authorization (AA) process and/or an above-physical layer (a layer above the physical layer) capability negotiation process, to obtain service information that can be provided by the network. The above-physical layer capability negotiation process includes a capability negotiation process of the link layer and/or above-link layer (a layer above the link layer).

In embodiments of the present invention, the negotiation of MIP capability includes one or more of the following ones:

(1) IP version negotiation: MS, ASN and CSN may support different IP versions, and the negotiation is performed to determine the IP version which is used after the MS enters the network.

(2) Session Initiation Protocol (SIP) and MIP negotiation: The negotiation is performed to determine whether to provide MIP service for the MS, and the ASN may further determine to provide Proxy MIP (PMIP) service or Client MIP (CMIP) service according to this information.

(3) Multiple IP address negotiation: The negotiation is performed to determine whether to provide multi-IP address capability for the MS.

(4) Multiple MIP registration capability negotiation: On the premise of providing MIP service, the negotiation is performed to determine whether to provide Multiple MIP registration capability for the MS.

(5) Reverse tunnel service negotiation: According to the subscription information of a subscriber, the service policy of the NSP/NAP, and the actual capability of the CSN/ASN, it is able to choose whether to provide reverse tunnel service. In the case of not providing reverse tunnel, the subscriber data is transmitted by means of third party routing.

(6) Route Optimization (RO) negotiation: MIPv6 supports RO function and this negotiation is performed to determine whether to provide the RO service to the MS. The RO function may have great influence on the real time performance of subscriber service.

(7) Service type negotiation: There are various service types, including Fixed Model, Nomadic Model, Portable Model, Simple Mobile Model, and Full Mobile Model. This negotiation is performed to determine which service model is to be provided for the MS. Specifically, in the Fixed Model, the network side does not provide any mobility service, that is, neither handover function is provided nor roaming is supported; moreover, the network side does not provide power saving function, that is, neither Idle mode nor Sleep mode is supported. In the Nomadic Model, the network side provides roaming function on the basis of the Fixed Model, that is, access is available at different locations/networks. In the Portable Model, the network side provides some handover function on the basis of the Nomadic Model but the continuity of service after handover is not guaranteed, that is, the TCP/IP connection may be interrupted and the IP address may be reallocated. In the Simple Mobile Model, the network side provides Idle mode, Sleep mode and handover function (including MIP) on the basis of the Portable Model but the moving speed of the terminal is limited, that is, when the moving speed of the subscriber terminal arrives at 60˜120 Km/h, the data throughput may decrease; moreover, the application layer may be interrupted but the TCP/IP session may not be interrupted at the time of handover. In the Full Mobile Model, the network side supports higher moving speed of the terminal on the basis of the Simple Mobile Model, and guarantees the use of wireless services without interruption at the time of handover.

Detailed description for the invention will be provided in conjunction with the drawings hereafter.

### Embodiment 1

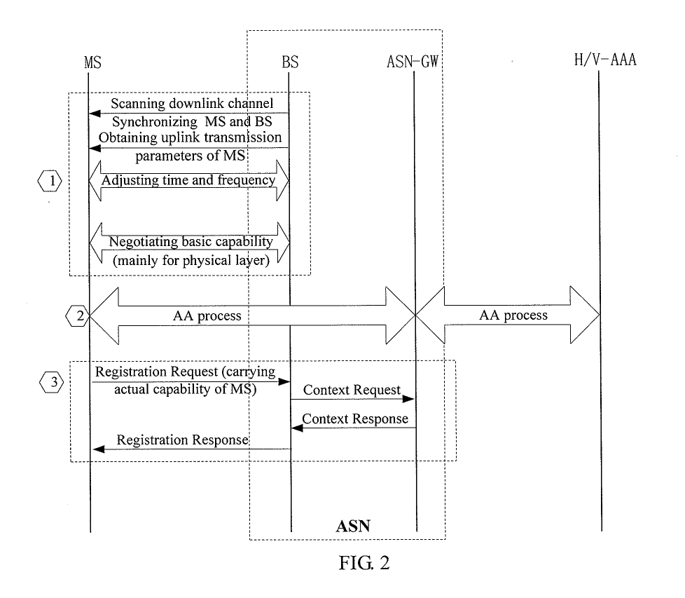

In the present embodiment, capability supported by an ASN and a CSN, service policy of a NAP, and subscription information of a subscriber are pre-configured in a BS or an ASN-GW. In a process of negotiation between an MS and the ASN, the BS or the ASN-GW determines service information that can be provided based on the pre-configured information. FIG. 2 illustrates a specific flowchart of a method for negotiating MIP capability in a network according to the present embodiment. The method includes:

Step 1: When an MS enters a network, downlink channel scanning is performed, synchronization between the MS and a BS is established, uplink transmission parameters of the MS are obtained, adjustment of time and frequency is performed, and negotiation of basic capability at the physical layer is completed;

Step 2: An authentication and authorization (AA) process is performed between the MS and a Home-Authentication Authorization and Accounting (H-AAA) server;

Step 3: The link layer and/or above-link layer capability negotiation, including the MIP capability negotiation, is performed.

The capability negotiation process of step 3 specifically includes:

Step 31: The MS sends to the BS a Registration Request carrying the current actual capability of the MS, and the MS informs the BS of the MS's current actual capability through the Registration Request;

Step 32: When the actual capability of the network (including an ASN and a CSN) and/or the service policy of the NSP are pre-configured in the BS, the BS determines the service information that can be provided by the system based on the current actual capability of the MS, the pre-configured actual capability of the ASN, actual capability of the CSN, service policy of the NSP, and/or subscription information of the subscriber, and sends to the MS, through a Registration Response, the determined service information that can be provided by the system, so as to inform the MS of the result of capability negotiation, including the result of MIP capability negotiation.

When the actual capability of the network and/or the service policy of the NSP are pre-configured in an ASN-GW, the step 32 further includes two cases as following:

In the first case, it is the ASN-GW that determines the result of the capability negotiation. Step 32 further includes:

Step 321: The BS sends to the ASN-GW a Context Request carrying the actual capability of the MS;

Step 322: After receiving the Context Request, the ASN-GW determines the service information that can be provided by the system based on the current actual capability of the MS, the pre-configured actual capability of the ASN, actual capability of the CSN, service policy of the NSP, and the subscription information of the subscriber, and feeds back to the BS through a Context Response the determined service information;

Step 323: After receiving the Context Response, the BS sends the Registration Response to the MS, so as to inform the MS of the result of capability negotiation, including the result of MIP capability negotiation.

In the second case, it is the BS that determines the result of the capability negotiation. Step 32 further includes:

Step 321′: After receiving the Registration Request, the BS sends to the ASN-GW a Context Request;

Step 322′: After receiving the Context Request, the ASN-GW determines the service information that can be supported by the network based on the pre-configured actual capability of the ASN, actual capability of the CSN, service policy of the NSP, and/or the subscription information of the subscriber, and feeds back to the BS through a Context Response the service information that can be supported by the network;

Step 323′: After receiving the Context Response, the BS determines the service information that can be provided by the system based on the actual capability of the MS and the service information that can be supported by the network, and sends to the MS through the Registration Response the determined service information.

The present embodiment performs the negotiation of MIP capability between the MS and the network through the link layer and/or above-link layer capability negotiation process of Step 3.

### Embodiment 2

In consideration of more general cases, an ASN may generally connect to multiple CSNs, and in a roaming situation, the ASN may even indirectly connect to a Home-CSN (H-CSN) via a Visited-CSN (V-CSN), at this time it may be unsuitable to pre-configure service information of the CSNs in the ASN. In such cases, the ASN may dynamically obtain the service information of a CSN through an authentication and authorization (AA) process of the MS, and then determine the service information that can be supported by the network.

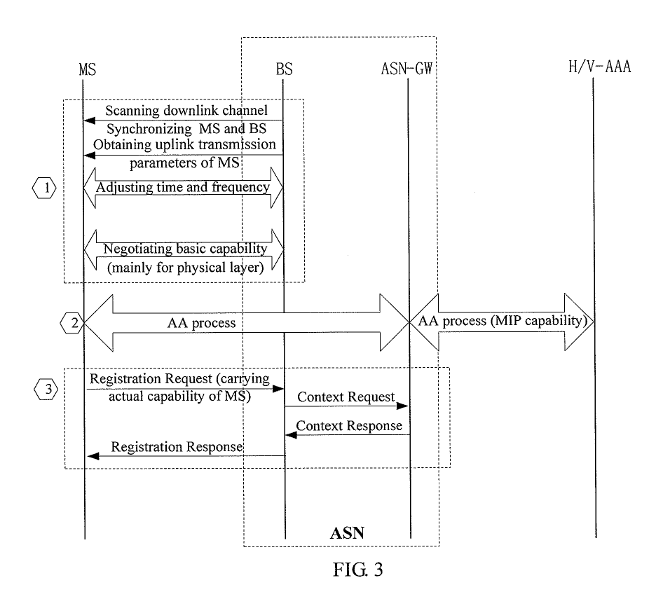

FIG. 3 illustrates a specific flowchart of a method for negotiating MIP capability in a network according to the present embodiment, the method includes:

Step 1: When a MS enters a network, downlink channel scanning is performed, synchronization between the MS and a BS is established, uplink transmission parameters of the MS are obtained, adjustment of time and frequency is performed, and physical layer basic capability negotiation is completed;

Step 2: An AA process is performed between the MS and an H-AAA server.

Specifically, there are two cases due to different decision points of the capability negotiation.

In the first case, the information is collected in the H-AAA server, and it is the H-AAA server that determines the service information that can be supported by the network. Step 2 further includes:

Step 21: The MS sends to an ASN-GW an AA Request;

Step 22: After receiving the AA Request, the ASN-GW sends to the H-AAA server an AA Request carrying the actual capability of the ASN and the service policy of the NAP.

Through the above steps, the ASN-GW sends to the H-AAA server through the AA Request the actual capability of the ASN and/or the service policy of the NAP.

If a Visited-AAA (V-AAA) server is needed to go through in the midway, the actual capability of the V-CSN and/or the service policy of the Visited-NSP (V-NSP) should also be sent to the H-AAA server through the AA Request.

Step 23: The H-AAA server determines the service information that can be supported by the network based on the subscription information of the subscriber, the actual capability of the H-CSN, the service policy of the NSP, and/or the information carried in the AA Request, and sends to the ASN-GW through an AA Response the service information that can be supported by the network.

In the second case, it is the ASN that determines the service information that can be supported by the network. Step 2 further includes:

Step 21′: The MS sends to an ASN-GW an AA Request;

Step 22′: After receiving the AA Request, the ASN-GW sends to the H-AAA server an AA Request;

It should be noted that, in the case that the ASN determines the service information that can be supported by the network, the AA Request need not carry the actual capability of the ASN and/or the service policy of the NAP.

Step 23′: Based on comprehensive consideration of the subscription information of the subscriber, the actual capability of the H-CSN, and/or the service policy of the NSP, the H-AAA server sends to the ASN an AA Response carrying the service information supported by the CSN;

In this way, the H-AAA server sends to the ASN through the AA Response the service information supported by the CSN, and the service information is stored in the ASN-GW. If a V-AAA server is needed to go through in the midway, the actual capability of the V-CSN and/or the service policy of the V-NSP should also be carried in the AA Response.

Steps 24′s: The ASN-GW determines the service information that can be supported by the network based on comprehensive consideration of the actual capability of the ASN, the service policy of the NAP, and/or the information carried in the AA Response.

Step 3: The link layer and/or above-link layer capability negotiation, which includes the MIP capability negotiation, is performed.

Step 3 specifically includes:

The MS sends to the BS a Registration Request carrying the current actual capability of the MS, and in this way the MS informs the BS of the MS's current actual capability through the Registration Request;

The ASN finally determines the service information that can be provided based on the service information that can be supported by the network, which is obtained in the AA process, as well as the actual capability of the MS, and/or the service policy of the NAP, and sends to the MS through a Registration Response the service information that can be provided.

Since the negotiation result sent at the step 2 is generally saved in the ASN-GW, the BS then needs to interact with the ASN-GW to complete the capability negotiation process. As shown in FIG. 3, similarly with the first embodiment, the capability negotiation process includes two cases due to different decision points: in the first case, it is the ASN-GW that determines the result of the capability negotiation; and in the second case, it is the BS that determines the result of the capability negotiation. Since the capability negotiation process of the present embodiment is similar to that of the first embodiment, details are not provided here.

In the step 2 of the present embodiment, it is required to carry information of service capability in the bearer protocol for Authentication and Authorization between the ASN and the AAA server, however, the existing protocol for Authentication and Authorization cannot carry the information of service capability. In the present embodiment, it may but not limited to employ Remote Authentication Dial In User Service (Radius) protocol (RFC2865) or Diameter protocol (RFC3588) as the protocol for the Authentication and Authorization.

### Embodiment 3

In the second embodiment, the negotiation of MIP capability between the MS and the network is implemented through an AA process and a link layer and/or above-link layer capability negotiation process. In the present embodiment, the MIP capability negotiation process may be implemented just through an AA process.

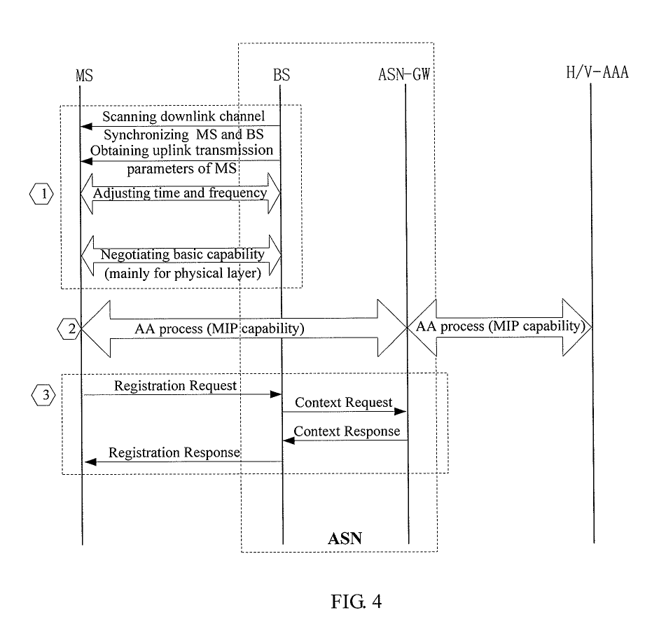

FIG. 4 illustrates a specific flowchart of a method for negotiating MIP capability in a network according to the present embodiment. The method includes:

Step 1: When a MS enters a network, downlink channel scanning is performed, synchronization between the MS and a BS is established, uplink transmission parameters of the MS are obtained, adjustment of time and frequency is performed, and physical layer basic capability negotiation is completed;

Step 2: An AA process is performed between the MS and an H-AAA server, so as to perform the negotiation of the MIP capability between the MS and the network.

Similar to the second embodiment, in the case that it is the H-AAA server that determines the service information that can be supported by the network, Step 2 specifically includes:

Step 21: The MS sends to an ASN-GW an AA Request carrying the actual capability of the MS, in this way, the MS informs the ASN-GW, through the AA Request, of the actual capability of the MS;

Step 22: After receiving the AA Request, the ASN-GW determines the service information supported by the ASN based on the actual capability of the ASN-GW and the service policy of the NAP, includes the service information supported by the ASN in an AA request, and sends the AA request to the H-AAA server;

If the AA Request go through a V-AAA server between the ASN-GW and the H-AAA server, the V-AAA server determines the service information supported by all of the MS, the ASN and the V-AAA server based on the service information supported by the ASN, the service policy of the V-NSP, and/or the actual capability of the V-CSN, and then sends to the H-AAA server the service information supported by all of the MS, the ASN and the V-AAA server;

Step 23: After receiving the AA request, the H-AAA server determines the service information that can be supported by the network based on comprehensive consideration of the service information carried in the AA Request, the subscription information of the subscriber, the actual capability of the H-CSN, and/or the service policy of the NSP, and sends to the ASN-GW an AA Response carrying the service information that can be supported by the network;

Step 24: After receiving the AA Response, the ASN-GW stores the corresponding service information, and sends to the MS the AA Response carrying the service information that can be supported by the network.

In the case that it is the ASN that determines the service information that can be supported by the network, Step 2 specifically includes:

Step 21′: The MS sends to an ASN-GW an AA Request carrying the actual capability of the MS, in this way, the MS informs the ASN-GW, through the AA Request, of the actual capability of the MS;

Step 22′: After receiving the AA Request, the ASN-GW sends to the H-AAA server the AA Request, which does not carry the actual capability of the ASN;

Step 23′: After receiving the AA request, the H-AAA server determines service information supported by the CSN based on comprehensive consideration of the actual capability of the MS, the actual capability of the H-CSN, and/or the service policy of the NSP, and sends to the ASN-GW an AA Response carrying the service information supported by the CSN;

Step 24′: After receiving the AA Response carrying the service information supported by the CSN, the ASN-GW determines the service information that can be supported by the network based on the service information supported by the CSN, the actual capability of the ASN, and/or the service policy of the NAP, and sends to the MS through the AA process the service information that can be supported by the network;

Step 3: The link layer and above-link layer capability negotiation is performed.

The capability negotiation process of Step 3 is shown in FIG. 4, and specifically is similar to those of the first and second embodiments, the difference lies in that the capability negotiation process of Step 3 in the present embodiment does not includes the MIP capability negotiation process between the MS and the network, details for the similar process are not provided here.

In the present embodiment, the requirement of carrying information of service capability in the AA process between the MS and the AAA server is satisfied by extension of Authentication and Authorization protocol. In the present embodiment, the Authentication and Authorization protocol may be, but not limited to, Extensible Authentication Protocol (EAP) (RFC3748) or Rivest-Shamir-Adelman (RSA) protocol (RFC3447).

The technology of carrying information of service capability in the protocol for Authentication and Authorization between the ASN and the AAA server is not disclosed in prior art. In the present embodiment, the protocol may be, but not limited to, Radius protocol (RFC2865) or Diameter protocol (RFC3588).

An embodiment of the present invention further provides an apparatus for negotiating MIP capability in a network. The apparatus performs the negotiation of the MIP capability through an AA process and/or a link layer and/or above-link layer capability negotiation process, so as to obtain service information that can be provided by the network.

An embodiment of the present invention further provides a network including an ASN and a CSN, wherein the ASN obtains the service information of the CSN through an AA process, and determines the service information that can be supported by the network.

In an above-physical layer capability negotiation process, the negotiation of MIP capability is performed between the ASN and the MS based on the service information that can be supported by the network, and the ASN determines the service information that can be provided by the network.

The ASN includes an ASN-GW, and the CSN includes an H-AAA server.

In the case that it is the H-AAA server that determines the service information that can be provided by the network, after the ASN-GW receives an AA Request from a subscriber terminal, the ASN-GW sends to the H-AAA server the actual capability of the ASN and/or the service policy of the NAP; after the H-AAA server receives the actual capability of the ASN and/or the service policy of the NAP, the H-AAA server determines the service information that can be supported by the network based on the actual capability of the ASN and/or the service policy of the NAP, as well as the subscription information of the subscriber, the actual capability of the H-CSN, and/or the service policy of the NSP, and sends to the ASN-GW the service information that can be supported by the network.

In the case of it is the ASN that determines the service information that can be provided by the network, after the H-AAA server receives the AA Request sent from the subscriber terminal, the H-AAA server determines the service information of the CSN based on the subscription information of the subscriber, the actual capability of the H-CSN, and/or the service policy of the NSP, and sends the service information of the CSN to the ASN-GW; after the ASN-GW receives the service information of the CSN, the ASN-GW determines the service information that can be supported by the network based on the service information of the CSN as well as the actual capability of the ASN, and/or the service policy of the NAP.

As stated in the second embodiment, the CSN may further include a V-AAA server. In this case, the actual capability of the V-CSN and/or the service policy of the V-NSP need to be considered in determining the service information that can be supported by the network.

If it is the BS in the ASN that stores the service information that can be supported by the network after the service information that can be supported by the network is obtained, the BS may, after receiving the actual capability of the MS, determine the service information that can be provided by the network based on the service information that can be supported by the network and the actual capability of the MS.

If it is the ASN-GW in the ASN that stores the service information that can be supported by the network, after the BS receives the actual capability of the MS, the BS may send the actual capability of the MS to the ASN-GW. After receiving the actual capability of the MS, the ASN-GW may determine the service information that can be provided by the network based on the saved service information that can be supported by the network and the actual capability of the MS.

Moreover, after receiving the actual capability of the MS, the BS may further send to the ASN-GW a Context Request. After receiving the Context Request, the ASN-GW sends to the BS the service information that can be supported by the network. After receiving the service information that can be supported by the network, the BS determines the service information that can be provided by the network based on the actual capability of the MS and the service information that can be supported by the network.

According to the invention, the network allows the service provider to choose whether to provide MIP and relevant service.

It should be understood that, although the WiMAX system is taken as example to illustrate above embodiments, it is apparent for those skilled in the art that the technical solutions of the invention may be applied to other networks, in which access network is equivalent to the ASN in above embodiments and core network is equivalent to the CSN in above embodiment.

What is claimed is:

1. A method for negotiating Mobile Internet Protocol (MIP) capability in a network, comprising:
negotiating the MIP capability through an Authentication and Authorization (AA) process and/or an above-physical layer capability negotiation process, to obtain service information that can be provided by the network.

2. The method of claim 1, wherein the negotiation of the MIP capability through the AA process and the above-physical layer capability negotiation process comprises:
obtaining, by an ASN, service information that can be supported by the network through the AA process; and,
in the above-physical layer capability negotiation process, performing, by the ASN, the negotiation of the MIP capability with a subscriber terminal, based on the service information that can be supported by the network, to determine the service information that can be provided by the network.

3. The method of claim 2, wherein the AA process comprises:
sending actual capability of the ASN and/or service policy of a Network Access Provider (NAP) from an ASN-GW to a Home-Authentication Authorization and Accounting (H-AAA) server, after the ASN-GW receives an AA Request from the subscriber terminal; and
receiving, by the ASN-GW, the service information that can be supported by the network, which is determined by the H-AAA server based on the actual capability of the ASN and/or the service policy of the NAP, as well as subscription information of the subscriber, actual capability of a Home-CSN (H-CSN) and/or service policy of a Network Service Provider (NSP), after the H-AAA server receives the actual capability of the ASN and/or the service policy of the NAP.

4. The method of claim 2, wherein the AA process comprises:
sending actual capability of the ASN and/or service policy of a NAP from an ASN-GW to a Visited-Authentication Authorization and Accounting (V-AAA) server, after the ASN-GW receives an AA Request from the subscriber terminal;
sending from the V-AAA server to an H-AAA server the actual capability of the ASN and/or the service policy of the NAP, as well as actual capability of a Visited-CSN (V-CSN) and/or service policy of a Visited-Network Service Provider (V-NSP), after the V-AAA server receives the actual capability of the ASN and/or the service policy of the NAP; and
determining, by the H-AAA server after the H-AAA server receives the information from the V-AAA server, the service information that can be supported by the network, based on the received information as well as subscription information of the subscriber, actual capability of an H-CSN and/or service policy of an NSP, and sending the service information that can be supported by the network from the H-AAA server to the ASN-GW.

5. The method of claim 2, wherein the AA process comprises:
receiving, by an ASN-GW, the service information of the CSN, which is determined by an H-AAA server, based on subscription information of the subscriber, actual capability of an H-CSN and/or service policy of an NSP, after the H-AAA server receives an AA Request sent from the subscriber terminal; and
determining, by the ASN-GW, the service information that can be supported by the network, based on the received service information of the CSN as well as actual capability of an ASN and/or service policy of a NAP.

6. The method of claim 2, wherein the AA process comprises:
determining, by an H-AAA server, service information of an H-CSN, based on subscription information of the subscriber, actual capability of an H-CSN and/or service policy of an H-NSP after the H-AAA server receives an AA Request sent from the subscriber terminal, and sending the service information of the H-CSN from the H-AAA server to a V-AAA server; and
sending from the V-AAA server to an ASN-GW the received service information of the H-CSN, actual capability of a V-CSN, and/or service policy of a V-NSP, after the V-AAA server receives the service information of the H-CSN; and
after the ASN-GW receives the service information of the H-CSN, actual capability of a V-CSN, and/or service policy of a V-NSP from the V-AAA server, determining, by the ASN-GW, the service information that can be supported by the network, based on the received service information of the H-CSN, actual capability of a V-CSN, and/or service policy of a V-NSP as well as actual capability of an ASN and/or service policy of a NAP.

7. The method of claim 2, wherein the service information that can be supported by the network is stored in a BS (Base Station) and the above-physical layer capability negotiation process comprises:
determining, by the BS, the service information that can be provided by the network, based on actual capability of the subscriber terminal, as well as the service information that can be supported by the network, actual capability of an ASN, and/or service policy of a NAP, after the BS receives the actual capability of the subscriber terminal.

8. The method of claim 2, wherein the service information that can be supported by the network is stored in an ASN-GW and the above-physical layer capability negotiation process comprises:
sending from a BS to the ASN-GW actual capability of the subscriber terminal after the BS receives the actual capability of the subscriber terminal;
determining, by the ASN-GW, the service information that can be provided by the network, based on the actual capability of the subscriber terminal, as well as the service information that can be supported by the network after the ASN-GW receives the actual capability of the subscriber terminal.

9. The method of claims 8, further comprising:
sending from the ASN-GW to the subscriber terminal via a BS the service information that can be provided by the network.

10. The method of claim 1, wherein the negotiation of the MIP capability comprises one or more of IP version negotiation, Simple IP (SIP) and MIP supporting capability negotiation, multi-IP address supporting capability negotiation, multi-MIP registration supporting capability negotiation, reverse tunnel service supporting capability negotiation, Route Optimization (RO) supporting capability negotiation, and service type negotiation.

11. A method for obtaining service information that can be supported by a network, comprising:
obtaining, by an Access Service Network (ASN), the service information that can be supported by the network through an Authentication and Authorization (AA) process.

12. The method of claim 11, wherein the AA process comprises:
sending actual capability of the ASN and/or service policy of a Network Access Provider (NAP) from an ASN-Gateway (ASN-GW) to a Home-Authentication Authorization and Accounting (H-AAA) server, after the ASN-GW receives an AA Request from a subscriber terminal; and
receiving, by the ASN-GW, the service information that can be supported by the network, which is determined by the H-AAA server, based on the actual capability of the ASN and/or the service policy of the NAP, as well as subscription information of the subscriber, actual capability of a Home-Connectivity Service Network (H-CSN) and/or service policy of a Network Service Provider (NSP) after the H-AAA server receives the actual capability of the ASN and/or the service policy of the NAP.

13. The method of claim 11, wherein the AA process comprises:
sending actual capability of the ASN and/or service policy of a NAP from an ASN-GW to a Visited-Authentication Authorization and Accounting (V-AAA) server, after the ASN-GW receives an AA Request from a subscriber terminal; and
sending from the V-AAA server to an H-AAA server the actual capability of the ASN and/or the service policy of the NAP, as well as actual capability of a Visited-Connectivity Service Network (V-CSN) and/or service policy of a Visited-Network Service Provider (V-NSP) after the V-AAA server receives the actual capability of the ASN and/or the service policy of the NAP; and
determining, by the H-AAA server after the H-AAA server receives the information from the V-AAA server, the service information that can be supported by the network, based on the received information as well as subscription information of the subscriber, actual capability of an H-CSN and/or service policy of an NSP, and sending the service information that can be supported by the network from the H-AAA server to the ASN-GW.

14. The method of claim 11, wherein the AA process comprises:
receiving, by an ASN-GW, the service information of the CSN, which is determined by an H-AAA server, based on subscription information of the subscriber, actual capability of an H-CSN and/or service policy of an NSP, after the H-AAA server receives an AA Request sent from the subscriber terminal; and
determining, by the ASN-GW, the service information that can be supported by the network, based on the received service information of the CSN as well as actual capability of an ASN and/or service policy of an NAP.

15. The method of claim 11, wherein the AA process comprises:
determining, by an H-AAA server, service information of an H-CSN, based on subscription information of a subscriber, actual capability of an H-CSN and/or service policy of an H-NSP after the H-AAA server receives an AA Request sent from a subscriber terminal, and sending the service information of the H-CSN from the H-AAA server to a V-AAA server; and
sending from the V-AAA server to an ASN-GW the received service information of the H-CSN, actual capability of a V-CSN, and/or service policy of a V-NSP, after the V-AAA server receives the service information of the H-CSN; and
after the ASN-GW receives the service information of the H-CSN, actual capability of a V-CSN, and/or service policy of a V-NSP from the V-AAA server, determining, by the ASN-GW, the service information that can be supported by the network, based on the received service information of the H-CSN, actual capability of a V-CSN, and/or service policy of a V-NSP as well as actual capability of an ASN and/or service policy of a NAP.

16. An apparatus for negotiating Mobile Internet Protocol (MIP) capability in a network, wherein the apparatus is adapted to negotiate the MIP capability through an Authentication and Authorization (AA) process and/or an above-physical layer capability negotiation process, so as to obtain service information that can be provided by the network.

17. A network comprising an Access Service Network (ASN) and a Connectivity Service Network (CSN), wherein the ASN is adapted to obtain service information that can be supported by the network through an Authentication and Authorization (AA) process.

18. The network of claim 17, wherein the ASN comprises an ASN-Gateway (ASN-GW), and the CSN comprises a Home-Authentication Authorization and Accounting (H-AAA) server; and wherein
the ASN-GW is adapted to send actual capability of the ASN and/or service policy of a Network Access Provider (NAP) to the H-AAA server, after the ASN-GW receives an AA Request from a subscriber terminal; and
the H-AAA server is adapted to determine the service information that can be supported by the network, based on the actual capability of the ASN and/or the service policy of the NAP, as well as subscription information of the subscriber, actual capability of a Home-CSN (H-CSN) and/or service policy of a Network Service Provider (NSP) after the H-AAA server receives the actual capability of the ASN and/or the service policy of the NAP, and send the service information that can be supported by the network to the ASN-GW.

19. The network of claim 17, wherein the ASN comprises an ASN-GW, and the CSN comprises an H-AAA server and a Visited-Authentication Authorization and Accounting (V-AAA) server; and wherein
the ASN-GW is adapted to send actual capability of the ASN and/or service policy of a NAP to the V-AAA server after the ASN-GW receives an AA Request from a subscriber terminal;
the V-AAA server is adapted to send to the H-AAA server the actual capability of the ASN and/or the service policy of the NAP, as well as actual capability of a Visited-CSN (V-CSN) and/or service policy of a Visited-Network Service Provider (V-NSP), after the V-AAA server receives the actual capability of the ASN and/or the service policy of the NAP; and
the H-AAA server is adapted to determine, after the H-AAA server receives the actual capability of the ASN and/or the service policy of the NAP, as well as the actual capability of the V-CSN and/or the service policy of the V-NSP from the V-AAA server, the service information that can be supported by the network, based on the actual capability of the ASN and/or the service policy of the NAP, the actual capability of the V-CSN and/or the service policy of the V-NSP, as well as subscription information of the subscriber, actual capability of an H-CSN and/or service policy of an NSP, and send the service information that can be supported by the network to the ASN-GW.

20. The network of claim 17, wherein the ASN comprises an ASN-GW, and the CSN comprises an H-AAA server; and wherein
the H-AAA server is adapted to determine service information of the CSN, based on subscription information of a subscriber, actual capability of an H-CSN and/or service policy of an NSP after the H-AAA server receives an AA Request sent from a subscriber terminal, and send the service information of the CSN to the ASN-GW; and
the ASN-GW is adapted to determine the service information that can be supported by the network, based on the service information of the CSN as well as actual capability of the ASN and/or service policy of a NAP.

21. The network of claim 17, wherein the ASN comprises an ASN-GW, and the CSN comprises an H-AAA server and a V-AAA server; and wherein
the H-AAA server is adapted to determine service information of an H-CSN, based on subscription information of a subscriber, actual capability of an H-CSN and/or service policy of an NSP after the H-AAA server receives an AA Request sent from a subscriber terminal, and send the service information of the H-CSN to the V-AAA server;
the V-AAA server is adapted to send to the ASN-GW the service information of the H-CSN, actual capability of a V-CSN, and/or service policy of a V-NSP after the V-AAA server receives the service information of the H-CSN; and
the ASN-GW is adapted to determine the service information that can be supported by the network, based on the service information of the H-CSN, the actual capability of the V-CSN, and/or the service policy of the V-NSP, as well as actual capability of the ASN and/or service policy of a NAP after the ASN-GW receives the service information of the H-CSN, the actual capability of the V-CSN, and/or the service policy of the V-NSP.

22. The network of claim 17, wherein in an above-physical layer capability negotiation process, a negotiation of Mobile Internet Protocol (MIP) capability is performed between the ASN and the subscriber terminal, based on the service information that can be supported by the network, to determine service information that can be provided by the network.

23. The network of claim 22, wherein the ASN further comprises a BS, and the BS is adapted to store the service information that can be supported by the network, and determine the service information that can be provided by the network, based on actual capability of the subscriber terminal as well as the service information that can be supported by the network after the BS receives the actual capability of the subscriber terminal.

24. The network of claim 22, wherein the ASN further comprises a BS, and wherein
the BS is adapted to send to the ASN-GW actual capability of the subscriber terminal after the BS receives the actual capability of the subscriber terminal; and
the ASN-GW is adapted to store the service information that can be supported by the network, and determine the service information that can be provided by the network, based on the actual capability of the subscriber terminal as well as the stored service information that can be supported by the network after the ASN-GW receives the actual capability of the subscriber terminal.

25. The network of claim 22, wherein the ASN further comprises a BS, and wherein
the BS is adapted to send to the ASN-GW a Context Request after the BS receives actual capability of the subscriber terminal, and determine the service information that can be provided by the network, based on the service information that can be supported by the network as well as the actual capability of the subscriber terminal after the BS receives the service information that can be supported by the network from the ASN-GW; and
the ASN-GW is adapted to send to the BS the service information that can be supported by the network after the ASN-GW receives the Context Request.
